(19) United States
(12) Patent Application Publication
(10) Pub. No.: US 2010/0114693 A1
(43) Pub. Date: May 6, 2010

(54) System and method for developing software and web based applications

(76) Inventors: Ryan Steelberg, Irvine, CA (US); Chad Steelberg, Newport Beach, CA (US)

Correspondence Address: Thomas J. McWilliams, Esquire;Drinker Biddle & Reath LLP, One Logan Sqaure, 18th & Cherry Streets, Philadelphia, PA, 19103-6996, US

(21) Appl. No.: 12/590,343

(22) Filed: Nov. 6, 2009

Related U.S. Application Data
(63) Continuation-in-part of application No. 12/220,912, filed on Jul. 29, 2008.
Application No. 12/220,912 is a continuation-in-part of application No. 12/144,194, filed on Jun. 23, 2008.
Application No. 12/144,194 is a continuation-in-part of application No. 11/981,646, filed on Oct. 31, 2007.
Application No. 11/981,646 is a continuation-in-part of application No. 11/981,837, filed on Oct. 31, 2007.
Application No. 11/981,837 is a continuation-in-part of application No. 12/072,692, filed on Feb. 27, 2008.
Application No. 12/072,692 is a continuation-in-part of application No. 12/079,769, filed on Mar. 27, 2008.
Application No. 12/079,769 is a continuation-in-part of application No. 12/042,913, filed on Mar. 5, 2008.
Application No. 12/042,913 is a continuation-in-part of application No. 12/072,692, filed on Feb. 27, 2008.
Application No. 12/072,692 is a continuation-in-part of application No. 11/981,646, filed on Oct. 31, 2007.
(60) Provisional application No. 61/111,778, filed on Nov. 6, 2008.
(60) Provisional application No. 61/065,297, filed on Feb. 7, 2008.
(60) Provisional application No. 61/131,386, filed on Jun. 6, 2008.
(60) Provisional application No. 60/993,096, filed on Sep. 7, 2007.

(51) Int. Cl. G06Q 30/00; G06Q 10/00

(52) U.S. Cl. 705/14.45; 705/310; 705/14.72; 705/14.53

(57) ABSTRACT

A widget composition engine is described. The engine includes a vault, which includes a plurality of media assets associated with different brand categories, a plurality of rule assets, associated with the vault and governing use of ones of the plurality of media assets and ones of the media assets returned responsive to searches in accordance with the different brand categories, and at least one widget template associated with the vault, where ones of the plurality of media assets are placed into the at least one widget template to form the widget, in accordance with the governance by ones of the plurality of rule assets.

### CROSS-REFERENCE TO RELATED APPLICATIONS

This application claims priority to U.S. Provisional Patent Ser. No. 61/111,778 entitled “System and Method for Developing Software and Web Based Applications,” filed Nov. 6, 2008, the entire disclosure of which is incorporated by reference herein as if set forth in its entirety.

### FIELD OF THE INVENTION

The present invention is directed to an advertising engine and, more particularly, to an engine for generation of brand affinity content, and a method of making and using same.

### BACKGROUND OF THE INVENTION

High impact advertising is that advertising that best grabs the attention of a target consumer. A target consumer is the ideal customer for the particular goods being advertised, from a socio-economic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Factors that will increase the impact of an endorser include the endorser's perceived knowledge of particular goods or in a particular industry, the fame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for the obtaining of an endorsement or sponsorship, in the aforementioned high-impact circumstances, either from a specific individual, a specific entity, an affinity brand, a marketing partner, or a sponsor.

### SUMMARY OF THE INVENTION

A widget composition engine, system and method is described. The engine, system and method includes a vault, which includes a plurality of media assets associated with different brand categories, a plurality of rule assets, associated with the vault and governing use of ones of the plurality of media assets and ones of the media assets returned responsive to searches in accordance with the different brand categories, and at least one widget template associated with the vault, where ones of the plurality of media assets are placed into the at least one widget template to form the widget, in accordance with the governance by ones of the plurality of rule assets.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates an exemplary embodiment of the present invention;

FIG. 2 illustrates an exemplary embodiment of the present invention;

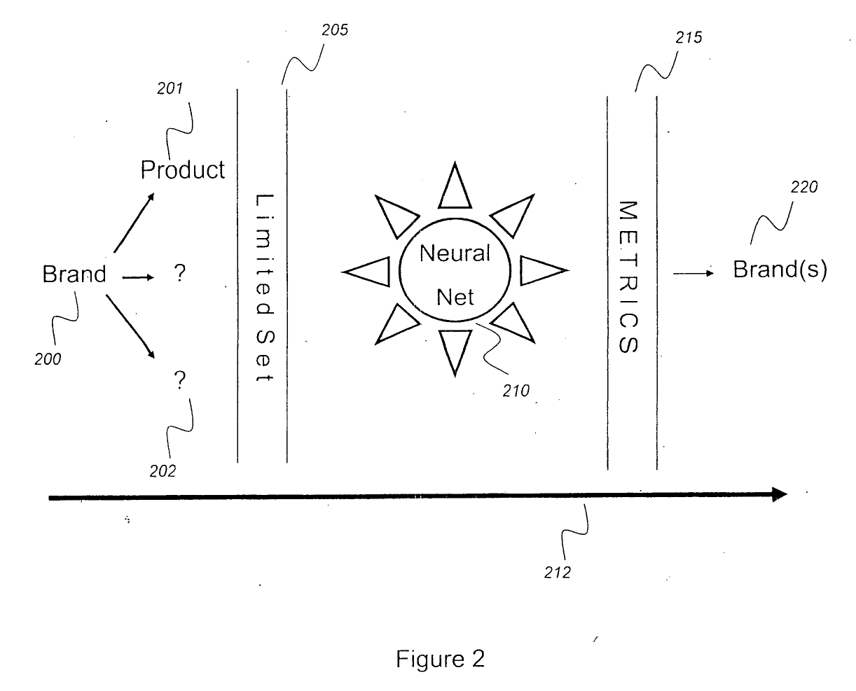

FIG. 3 illustrates an exemplary embodiment of the present invention; and

FIG. 4 illustrates an exemplary embodiment of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical advertising engines, systems and methods. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

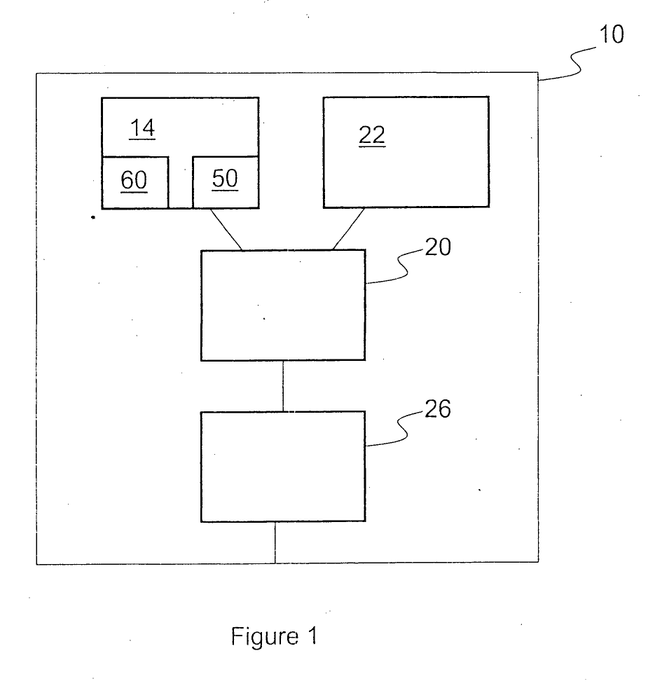

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 1, may include a vault 12 that provides media assets 14 and integration of media assets without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, late stage binding of the ad 22 and media asset 16 upon delivery to strongest target consumers, and delivery of the ad 22 and the dynamic media asset 16 from the vault to an advertiser or advertising server, which then places the mash up of the ad and media asset. Ad requests 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free.

Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlaid over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography and demographic information. Gathered data intelligence may be used as individual properties in conjunction with each other to form or produce the level of intelligence needed to achieve the desired efficiencies. By way of further example, data intelligence may also include information regarding the number of impressions an ad has received, the elapsed time between an impression or a click.

Utilizing the data intelligence will allow the delivery engine 26 to optimize targeting to new and past targets. Optimization may include efficiencies of time and control over redundancies and ad targeting. Optimization will allow for the prediction of probable impressions or clicks that a certain ad or creative may receive when, for example, pointed towards certain factors, such as demographic and geography, for example. A prediction may also be made regarding the efficiency of paid searches and may be further contrasted with, for example, display ads. Such information as drawn from the data intelligence may also allow for the higher success rates related to redundant ad placement based on the prior behavior of a particular audience. The same can be true for the avoidance of redundancy when, for example, data intelligence may be used to keep certain ads or creatives from repeatedly reaching an audience with, for example, low click-through rates. Redundancy avoidance may also include the avoidance of competing ads or creatives, whether or not placed for the same entity.

The delivery engine 26 may also choose to deactivate and/or modify certain creatives based on data intelligence and/or user direction. By way of non-limiting example, the data intelligence may be collected from several ad or creative types over any number of varying media formats, allowing for even more sophisticated optimization based on the allocation of impressions and clicks in the various media formats. Media formats may include, but are not limited to, internet, TV., radio, mobile devices, kiosks, billboards, product placements, and print. By further way of non-limiting example, data intelligence gathered during a run of a creative on the radio may effect the play of an ad on the internet. The delivery engine 26 may additionally allow for the interplay between data intelligence and real time metrics or community-based information. This real time intelligence gathering may also be used to calibrate a campaign(s) of multiple ads or creatives. By way of non-limiting example only, a campaign of with several creative versions may be measured based on gathered data intelligence and optimized to improve, for example, click-through. Such optimization may be done in real time and over multiple media types. The optimization may, by way of further non-limiting example, call for the addition of ads or creatives not currently apart of the campaign(s). Thus suggesting what type of ads or creatives are required for maximum optimization regardless of whether or not the ads or creatives reside in inventory.

Optimization of ads and creatives increases the value of ad and creative inventory and may, for example, provide for greater value pre and post delivery. The data intelligence may also allow for real-time valuations based on pre-existing and predicted variables, thus maximizing the value of the placed ad or ad/creative inventory. Value can be also maximized for premium and non-premium content. Functionality within the delivery engine 26 may also allow for variable rate sampling and frequency cap forecasting.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

Further, it is known in the existing art to engage in a myriad of different types of advertisement online. Two such advertisement types are: a search advertising model, in which a user undertakes to search for a good or service of interest and receives, as part of or as indicated with a search result(s), advertisements relevant to purchasing the good or service for which the search was made and/or to purchasing goods or services related to the good or service for which the search was made; and a display advertising model, in which a user is actively viewing a web site and receives, as part of the web site under review, advertisements for the purchase of goods or services relevant to the content of the web site under review. Needless to say, the former operates on the principal that, if a user searches for a good or service, he/she would like to buy that good or service, and the latter operates on the principal that if a user is interested enough in the content of a web site to view that web site, he/she is also likely interested in buying goods or services related to the content of that web site.

The display advertising model mentioned hereinabove is typically embodied as banner on a web site. For example, such banners may appear above, below, to the left, or to the right of the content being viewed, but typically do not impinge upon the content being viewed. The search advertising model mentioned hereinabove is typically embodied as advertisements/banners placed proximate to search results on the search results page responsive to the user search. For example, such advertisements may appear along a right hand side of a search results page, while the search results are displayed along the left hand side of the same search results page.

As discussed immediately above, it is necessarily the case that the correlations performed between the user's searched or viewed content and the advertisements provided will increase the relevance of, and thus the response to, the advertisements. However, such responses in the form of either clicks on the advertisements or purchases made through the advertisement link, once obtained at a particular rate, cannot be further improved by the relevance of the advertisements produced. Rather, the only manner to improve the response rate once relevant advertisements are produced is to improve the advertisements themselves based on the users viewing the advertisements.

The present invention provides such improved response advertisement through the provision of brand affiliations with the goods and services being advertised, as discussed hereinthroughout. As discussed, the present invention allows for the production of advertisements having brand sponsorship that is optimized to the market sought. That is, the brand sponsor selected for an advertised good or service is, though the use of the present invention, selected to best correspond to the characteristics of the purchaser sought by the advertisement.

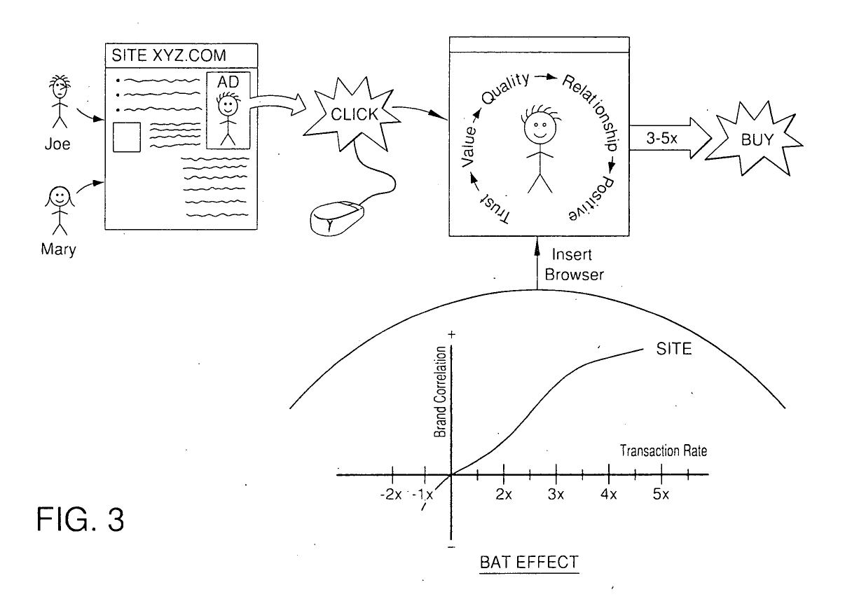

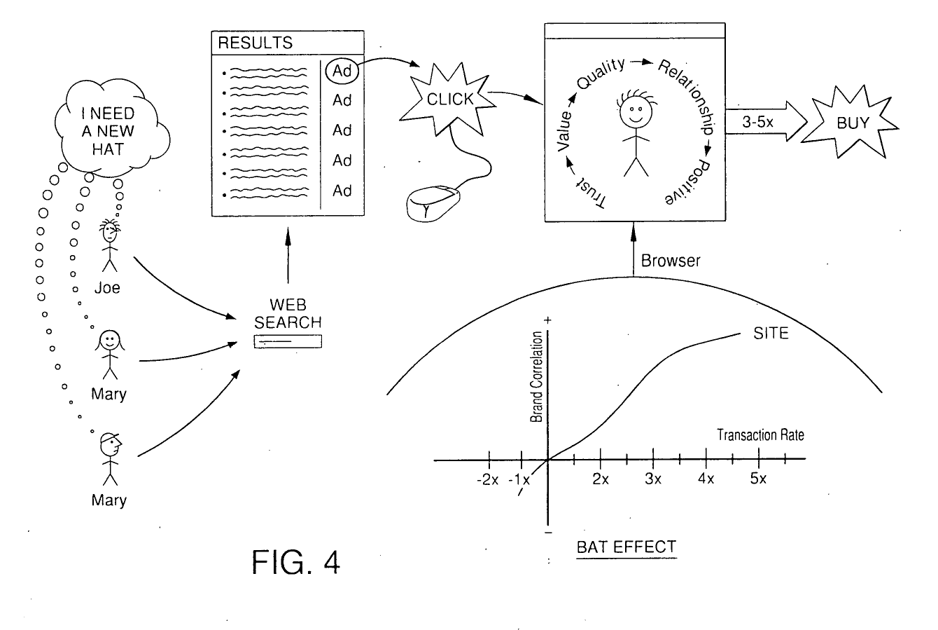

This effect is illustrated with respect to FIGS. 3 and 4. FIG. 3 illustrates the effect of the present invention with regard to a search advertising model, and FIG. 4 illustrates the effect of the present invention with respect to a display advertising model. In each Figure, a brand sponsor has been selected who will indicate, to the user for whom the advertisement is deemed most relevant, trust, quality, value, a relationship to the user, and/or an overall positive feeling. The sponsor is either selected by the advertiser in the present invention for inclusion with the subject advertisement, based on the profile of a desired purchaser and the characteristics of that sponsor as they relate to that profile, which relation is set forth or suggested by the present invention, or the sponsor is selected by the present invention for inclusion in or with the subject advertiser's advertisement based on a desired responder profile for the advertisement entered by the advertiser to the engine of the present invention.

As illustrated graphically in FIGS. 3 and 4, a positive correlation of a brand sponsor to a brand, which is necessarily also a correlation of a brand sponsor to those purchasers most interested in buying the subject brand, correlates positively to a increased transaction rate. In other words, to the extent the present invention provides brand affiliations, sponsorships, and the like that are well-suited to the sponsored brand, that brand will show an increase in the number of users who are shown that advertisement and that either click that advertisement or purchase that brand through that advertisement. It is estimated that the increase in the desired response rate in accordance with the use of the present invention may typically be a 3 to 5 times increase, based on the increased positive correlation between the sponsored brand and the brand sponsor provided by the present invention, although those skilled in the art will understand that more or less improvement in the transaction rate may occur based on the implementation of the present invention.

Thus, in accordance with the present invention, and as illustrated in FIGS. 3 and 4, an increased correlation of a brand sponsor to a sponsoring brand, and thus an increased correlation of a sponsoring brand to a desired purchaser's profile, is provided. This increased correlation generates an improved transaction rate in accordance with the present invention, for at least a search advertising model and a display advertising model.

While the present invention has been generally described to serve as an engine for the development of advertisements and advertising campaigns, the present invention may alternatively be used to develop or otherwise construct software and web based applications that might incorporate any of the various assets as described herein, for any purpose. For example, the present invention may be used to construct widgets, web banners, social networking programs and/or pages, or even be used as a research engine, such as performing legal research, mapping of nucleic acid or protein sequences, or any other form of analysis that might require the search and collection of data or assets electronically available via a communications network.

For example, a widget, which may also be known as modules, plug-ins or snippets, can be anything embedded within a web page, such as an HTML page. Generally, widgets are non-static programming that are constructed by a third party to add content to the page in question, such as a java applet. Widgets are often used by bloggers, social network users, auction sites and owners of personal web sites. Widgets can be distributed via platforms, such as Clearspring and Gigya, which can also seed and distribute widgets as rich media advertisement units. Widget applications may be integrated within a third party website by the placement of code to bring in content from a third party site. This mechanism allows the content to come in without the web site owner having to update the web site.

The present invention may provide widget developers a method of constructing and managing widgets that work on any web page, such as a blog or social networking home page. For example, in addition to the aforementioned vault assets, which may be constituted by available media related to one or more talents, such as a music video by a famous artist, for example, the vault may include a plurality of templates, such as widget templates, where assets may be pre-approved or available for approval by the generators of the media assets in the vault. Thereby, a requesting user may be enabled to associate multiple media assets with a widget for use, for example, in the requesting user's blog. Such widgets may be governed by rules that also comprise assets within the vault. For example, a musical artist may preclude use of her media asset in a widget that also includes an asset from another artist, or from any other artist. Accordingly, such widgets, once created, may be placed into the vault as assets to be subsequently associated with the subject asset talent.

Because web banners may be monitored in real-time and may be targeted to a viewer's interests, the present invention may provide an ideal mechanism to construct a web banner or banner ad. Banners generally include the embedding of an advertisement into a web page, with the goal of attracting traffic to a website by linking the banner to the website of the advertiser. Using the system of the present invention, the advertisement may be constructed from available assets, often employing animation or sound to maximize presence on the page. The present invention may allow images, or creatives, to be converted to a high-aspect ratio shape to give the appearance of a “banner”, for example. The creatives may then be placed on targeted web pages that have high traffic, are related or conducive to the advertised product or service, or any combination of the two. After construction, the banner may be displayed when the web page that references the banner is loaded into a web browser. When a viewer clicks on the banner, the viewer may be directed to the advertised location linked via the banner.

Because the system of the present invention uniquely tags, categorizes, and metricizes all types of media assets, the present invention may further perform a search and comparative analysis to recommend pages for embedding the constructed banner. Additionally, the banner may be delivered by the system of the present invention, or the system may coordinate such delivery with a third party ad server. As described herein, the system of the present invention may create and record logfiles, and may further detect that a viewer has visited the advertised location by clicking on the banner. In the case where a user wants to separately account for the provided content, or the content provider is a third party, the system may optionally send the content provider a fee.

According to another aspect of the present invention, the system may provide a platform for constructing social networking programs and/or pages, and may provide high-level targeting of creatives, ad campaigns or other branded applications. For example, the social networking website, Facebook, allows users to join one or more networks, organized by city, workplace, school, and region. These networks help users connect with other members of the same or similar network. Users can also connect with friends, or grant access to their friends' personally constructed profiles. For example, users create profiles including photos and lists of personal interests, exchange private or public messages, and join groups of friends. The viewing of detailed profile data may be accessible to users based on privacy settings established by the member of the network account.

Social networking websites may thus provide a framework for software developers to create applications using the system of the present invention that can interact with core social networking website features. For example, the system of the present invention may provide users or developers of the social networking website the ability to construct creatives or other programming for embedding within the website pages, or for delivery to users of the website, such as virtual gifts, ad postings, alerts, or any form of file sharing, in the manner discussed hereinthroughout.

According to another aspect of the present invention, the system may be used to conduct technical or legal research, or any form of research or analysis that might require the search and collection of data or assets electronically available via a communications network. For example, all legal documents within a law firm may be categorically identified as assets in the vault of the present invention, thereby making all such documents readily obtainable using the engines of the present invention, such as via searching based on the assigned asset categories of the document.

Similarly, for example, and as described previously, the present invention may provide a searchable archive of content from a range of sources, such as newspapers, magazines, legal documents and other electronically accessible databases, and further provides a searching mechanism for finding and identifying relevant content.

Further the present invention may be similarly useful in nearly any embodiment in which sequencing, numeric manipulation, data manipulation, or statistical assessment is required. For example, the nucleic acid sequencing, including the human genome project, and amino acid sequencing is typically preformed by a great number of national and private laboratories. The present invention, due to its categorization and sequencing of data capabilities, would be highly useful in such an embodiment. For example, not only could rules and information be entered that would allow for the sequencing data to become “assets” as described herein, but also the sharing between all such labs of all information related to the human genome via the search and repository capabilities may be performed. Additionally, the information available on the repository could be accessed, analyzed, matched for relevant homology and ordered in any desired manner once obtained, thus allowing for a unifying categorization and sequencing methodology for aspects of nucleic acid and amino acid sequencing research, as well as alleviation or total elimination of redundancies in the research process.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

We claim:

1. A widget composition engine, comprising:
a vault comprising a plurality of media assets associated with different brand categories;
a plurality of rule assets, associated with said vault and governing use of ones of the plurality of media assets and ones of the media assets returned responsive to searches in accordance with the different brand categories; and
at least one widget template associated with said vault, wherein ones of the plurality of media assets are placed into the at least one widget template to form the widget, in accordance with the governance by ones of said plurality of rule assets.

2. A widget composition engine of claim 1, wherein the governing rules assets vary based on a location of the widget.

3. A widget composition engine of claim 2, wherein the location is selected from a blog, a social network, a desktop, and a personal site.

4. A widget composition engine of claim 1, wherein said widget template comprises a plurality of incorporations from a widget platform.

5. A widget composition engine of claim 1, wherein the governing rules assets comprise an incorporation from a widget platform.

6. A widget composition engine of claim 1, wherein the widget comprises an advertisement.

7. A widget composition engine of claim 6, wherein the placed ones of the plurality of media assets into the widget comprise an endorsement.

8. A widget composition engine of claim 1, wherein the widget comprises an endorsed application.

9. A widget composition engine of claim 1, wherein ones of the media assets comprise at least one widget.

10. A widget composition engine of claim 1, wherein the governing rules assets vary based on a use of the widget.

11. A widget composition engine of claim 1, wherein said widget template comprises developer tools.

12. A widget composition engine of claim 1, wherein the widget comprises a banner.

13. A widget composition engine of claim 1, wherein the vault comprises at least one computing memory of at least one server.

14. A widget composition engine of claim 1, wherein the media assets are selected from the group consisting of movies, photos, games, audio and music videos.

15. A widget composition engine of claim 1, wherein the widget template comprises multiple quadrants.

16. A widget composition engine of claim 1, wherein the association of the rule assets with the vault comprises storage within the vault.

17. A widget composition engine of claim 1, wherein the searches comprise key word searches.

18. A widget composition engine of claim 1, wherein said plurality of rule assets comprises recommendation rules that recommend ones of the media assets for inclusion in the widget template.

19. A widget composition engine of claim 1, wherein the widget at least partially comprises a redirecting web link.

20. A widget composition engine of claim 1, wherein the widget comprises a tracker of interactions with the widget.
